(19) United States
(12) Patent Application Publication
(10) Pub. No.: US 2026/0023483 A1
(43) Pub. Date: Jan. 22, 2026

(54) TEMPERATURE STRESS ACCELERATION FACTOR IN NON-VOLATILE MEMORY

(71) Applicant: Micron Technology, Inc., Boise, ID (US)

(72) Inventor: Marco Redaelli, München (DE)

(21) Appl. No.: 18/777,316

(22) Filed: Jul. 18, 2024

(51) Int. Cl. G06F 3/06

(52) U.S. Cl. CPC G06F 3/0616; G06F 3/0659; G06F 3/0679

(57) ABSTRACT

A trapezoidal approximation of the Arrhenius equation provides an accurate determination of an acceleration factor for aging, while using minimal storage. The current temperature is periodically sampled. Based on the current temperature, a previous temperature, and a reference temperature, an acceleration factor for the device is updated. Then the sampled temperature is stored in place of the previous temperature, for use in updating the acceleration factor in the next period. The remaining lifespan may be determined based on a reference lifespan and the acceleration factor. As a result, the benefits of more accurate lifespan prediction are obtained without the costs of storing a sequence of temperatures experienced by the device.

### TECHNICAL FIELD

The present disclosure generally relates to managing temperature stress in memory systems.

### BACKGROUND

A memory system, such as a solid-state drive (SSD), can include one or more memory components that store data. The memory components can be, for example, non-volatile memory components and volatile memory components. In general, a host system can use a memory system to store data at the memory components and to retrieve data from the memory components.

Each of the memory components may have an expected lifespan. The lifespan can be measured by time, by a number of memory writes, by a number of memory reads, or by any suitable combination thereof. The expected lifespan of a particular component may depend on temperature.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory system in accordance with some embodiments of the present disclosure.

FIG. 2 shows a graph of average device lifespan for a memory component as a function of a fixed operating temperature, in accordance with some embodiments of the present disclosure.

FIG. 3 is a block diagram of an example data format for use in determining and using an acceleration factor for aging of a memory component, in accordance with some embodiments of the present disclosure.

FIG. 4 is a flow diagram of an example method for updating an acceleration factor for aging of a memory component, in accordance with some embodiments of the present disclosure.

FIG. 5 is a flow diagram of an example method for determining and applying an expected remaining lifespan of a memory component based on an acceleration factor, in accordance with some embodiments of the present disclosure.

FIG. 6 is a block diagram of an example computer system in which embodiments of the present disclosure may operate.

### DETAILED DESCRIPTION

Aspects of the present disclosure are directed to a memory system using an acceleration factor to predict a remaining lifespan of the memory system. An example of a memory system is a storage system, such as a solid-state drive (SSD). In general, a host system can use a memory system that includes one or more memory components. The host system can provide data to be stored at the memory system and can request data to be retrieved from the memory system.

The memory system can include multiple memory components that can store data from the host system. Different memory components can include different types of media. Examples of media include, but are not limited to, a cross-point array of non-volatile memory and flash-based memory cells.

The desired properties of the non-volatile memory may be achieved by using positively or negatively doped semiconductors. Over time, use of the non-volatile memory and the random motion of electrons may affect the doping, eventually causing the non-volatile memory to cease functioning. Higher temperatures increase the random motion of electrons in the semiconductor, and thus can cause positively and negatively doped semiconductors to approach a neutral state more quickly. As a result, the lifespan of a non-volatile memory may be affected by the temperatures experienced by the non-volatile memory.

Determining that a memory device will fail before it actually fails is important to allow any data stored in the memory device to be backed up. However, overly conservative estimates waste resources by causing memory devices to be discarded before their useful lifespan is complete. Since the lifespan of a device is affected by the temperature experienced by the device over time, simply predicting an average or minimum lifespan for the device at the time of manufacture is inadequate.

A conservative lifespan prediction may be made based on a maximum temperature experienced by the device. For example, a device temperature may be periodically sampled and, if the current temperature is greater than a stored maximum temperature, then the current temperature can be recorded as the maximum temperature. The lifespan of the device may be calculated or looked up based on the recorded maximum temperature. However, if the exposure of the device to the maximum temperature only lasted for a small duration of the life of the device, then the determined lifespan may be substantially smaller than the actual useful life of the device, resulting in premature discard of the device.

A more accurate lifespan prediction may be made by storing the temperatures experienced by the device as a time series. Device temperature information may be periodically sampled and stored. The lifespan of the device may be calculated based on the entire series of experienced temperatures. This calculation can be more accurate than the maximum temperature-based approach, and can help reduce waste of the entire device without increased risk of data loss. However, the storage space used (e.g., on the memory device itself, or on another device) to record the sequence of temperatures is substantial and may be prohibitive. For example, if temperature is stored as an 8-bit value every ten minutes and the device has a lifespan of ten years, 525,600 bytes of data will be used to store temperature data. The substantial additional storage used will increase one or more of the size, cost, and power consumption of the device.

As discussed herein, a trapezoidal approximation of the Arrhenius equation provides an accurate determination of an acceleration factor for aging, while using minimal storage. The approximation can include or use the following steps. The current device temperature is periodically sampled. Based on the current temperature, a previous temperature, and a reference temperature, an acceleration factor for the device is updated. Then the sampled device temperature is stored in place of the previous temperature, for use in updating the acceleration factor in the next period. The remaining lifespan may be determined based on a reference lifespan and the acceleration factor. As a result, the benefits of more accurate lifespan prediction are obtained without the costs of storing a sequence of temperatures experienced by the device.

The acceleration factor may be stored in a SMART (Self-Monitoring, Analysis, and Reporting Technology) log. SMART is a technology implemented in solid-state drives (SSDs) that enables monitoring and reporting of various drive attributes to assess device health and reliability. SSDs are non-volatile storage devices commonly used in computers and other electronic devices.

The equivalent of SMART for universal flash storage (UFS) and embedded multimedia card (eMMC) devices is Health Reports. UFS devices can provide health reports or status information through device-specific commands or vendor-specific tools. These reports may include information about wear leveling, erase counts, bad block management, and overall device health.

SMART attributes provide valuable information about the SSD's operational status, performance, and potential failure risks. These attributes can be monitored to detect early signs of degradation or impending failures, allowing users to take proactive measures such as data backup or drive replacement before critical data loss occurs.

The SMART data may include attributes such as temperature, read and write errors, reallocated sectors, wear leveling count, power-on hours, and more. These attributes may be continuously updated and stored in the SSD's firmware, which can be accessed by monitoring tools and diagnostic software.

SSD SMART monitoring has several benefits. SMART provides an early warning system for potential failures. By monitoring attributes such as reallocated sectors or uncorrectable errors, users can detect drive degradation in its early stages and take appropriate actions. SMART data can be used to optimize SSD performance. Monitoring parameters like wear leveling count and program/erase cycles helps gauge the drive's remaining lifespan and determine optimal data placement strategies. SMART monitoring enables predictive maintenance by tracking indicators such as power-on hours or drive temperature. By assessing these parameters, users can schedule timely maintenance activities or replacements to minimize the risk of unexpected failures. Continuous monitoring of SMART attributes helps prevent data loss. By identifying signs of imminent failures or degraded performance, users can back up critical data and replace drives before they become unreliable.

Using the systems and methods described herein, SMART monitoring is improved by more accurately predicting the acceleration factor for aging of a device, and thus, more accurately predicting the remaining lifespan of the device.

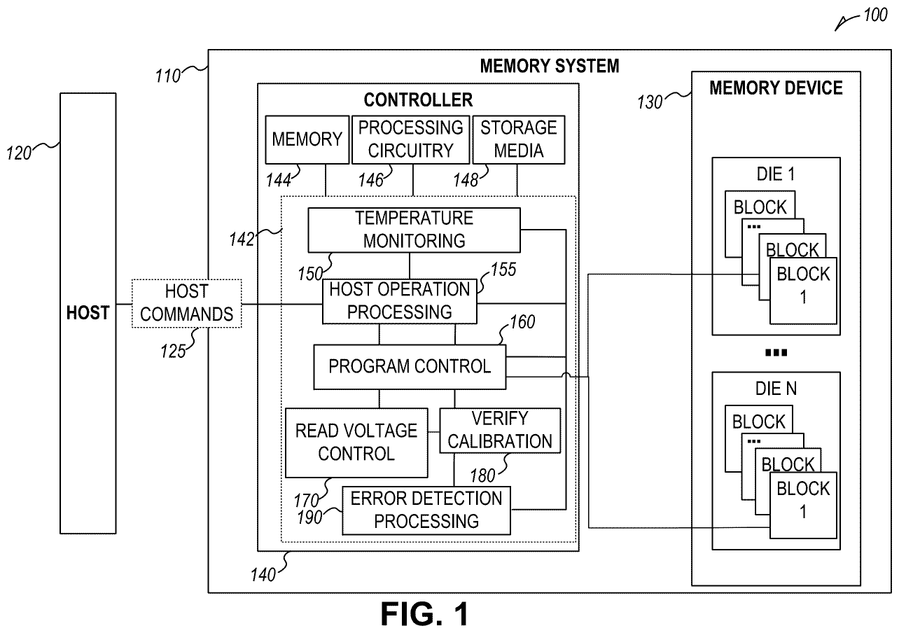

FIG. 1 provides a block diagram of an example system 100 including a memory system 110 (e.g., a SSD storage device, a SD/MMC card, etc.) having a memory controller 140 and a memory device 130. In an example, the functionality of control modules 142 of the memory controller 140 may be implemented in respective modules in a firmware of the memory controller 140. However, it will be understood that various forms of software, firmware, and hardware may be used by the controller 140 to implement the control modules 142 (e.g., implement the functionality of program control 160) and the other techniques discussed herein.

As shown, the memory system 110 includes a NAND memory device 130 with multiple dies (dies 1-N), with each die including one or more blocks (blocks 1-N). Each of the one or more blocks may include further divided portions, such as one or more wordlines (not shown) per block; and each of the one or more wordlines may be further comprised of one or more pages (not shown) per wordline, depending on the number of data states that the memory cells of that wordline are configured to store.

Accessing data from the memory device 130 may comprise applying a read voltage to a wordline, wherein the voltage applied to the wordline is different than the signaling voltage used to indicate that the voltage should be applied. A voltage level shifter may be used to convert the signaling voltage in a first power domain to the read voltage in a second power domain. By using the transition time reduction techniques and circuits discussed herein, the transition time for applying or ceasing to apply the read voltage may be reduced, improving performance of the memory device 130 by reducing power consumption, increasing operating frequency, or both.

In an example, the blocks of memory cells of the memory device 130 include groups of at least one of: single-level cell (SLC), multi-layer cell (MLC), triple-layer cell (TLC), or quad-layer cell (QLC) NAND memory cells. Also, in an example, the memory device 130 is arranged into a stack of three-dimensional (3D) NAND dies. These configurations and further detailed components of the memory device 130 are not illustrated in FIG. 1 for simplicity. However, the memory device 130 may incorporate these or any of the features described above with reference to features of 3D NAND architecture devices or other forms of NAND storage devices.

In 3D architecture semiconductor memory technology, vertical structures are stacked, increasing the number of tiers, physical pages, and accordingly, the density of a memory device (e.g., a storage device). In an example, the memory system 110 can be a discrete memory or storage device component of the host device 120. In other examples, the memory system 110 can be a portion of an integrated circuit (e.g., system on a chip (SOC), etc.), stacked or otherwise included with one or more other components of the host device 120.

Each flash memory cell in a NAND architecture semiconductor memory array may be programmed to two or more programmed states. For example, an SLC may represent one of two programmed states (e.g., 1 or 0), representing one bit of data. Flash memory cells may also represent more than two programmed states, allowing the manufacture of higher density memories without increasing the number of memory cells, as each cell may represent more than one binary digit (e.g., more than one bit). Such cells may be referred to as multi-state memory cells, multi-digit cells, or multi-level cells (MLCs). In certain examples, MLC may refer to a memory cell that may store two bits of data per cell (e.g., one of four programmed states), TLC may refer to a memory cell that may store three bits of data per cell (e.g., one of eight programmed states), and a QLC may store four bits of data per cell. MLC is used herein in its broader context, to refer to any memory cell(s) that may store more than one bit of data per cell (i.e., that may represent more than two programmed states; thus, the term MLC is used herein in the broader context, to be generic to memory cells storing 2, 3, 4, or more bits of data per cell).

The memory system 110 is shown as being operably coupled to a host device 120 via a controller 140 of the memory device. The controller 140 is adapted to receive and process host IO commands 125, such as read commands, write commands, erase commands, and the like, to read, write, erase, and manage data stored within the memory device 130. In other examples, the memory controller 140 may be physically separate from an individual memory device, and may receive and process commands for one or more individual memory devices. A variety of other components for the memory system 110 (such as a memory manager, and other circuitry or operational components) and the controller 140 are also not depicted for simplicity.

The controller 140 is depicted as including a memory 144 (e.g., volatile memory), processing circuitry 146 (e.g., a microprocessor), and a storage media 148 (e.g., non-volatile memory), used for executing instructions (e.g., instructions hosted by the storage media 148, loaded into memory 144, and executed by the processing circuitry 146) to implement the control modules 142 for management and use of the memory device 130. The functionality provided by the control modules 142 may include, but is not limited to: temperature monitoring 150 (e.g., to monitor temperature of the memory device 130); host operation processing 155 (e.g., to interpret and process the host IO commands 125, and to issue further commands to the NAND memory device 130 to perform respective read, write, erase, or other host-initiated operations); program control 160 (e.g., to control the timing, criteria, conditions, and parameters of scan operations on the memory device 130); read voltage control 170 (e.g., to establish, set, and use a program voltage level to read a particular portion of the memory device 130); verify calibration 180 (e.g., to operate a calibration procedure to identify a new programmed voltage level of a particular portion or portions of the memory device 130); and error detection processing 190 (e.g., to identify and correct errors from data obtained in read operations, to identify one or more raw bit error rates (RBERs) for a particular read operation or set of operations, etc.).

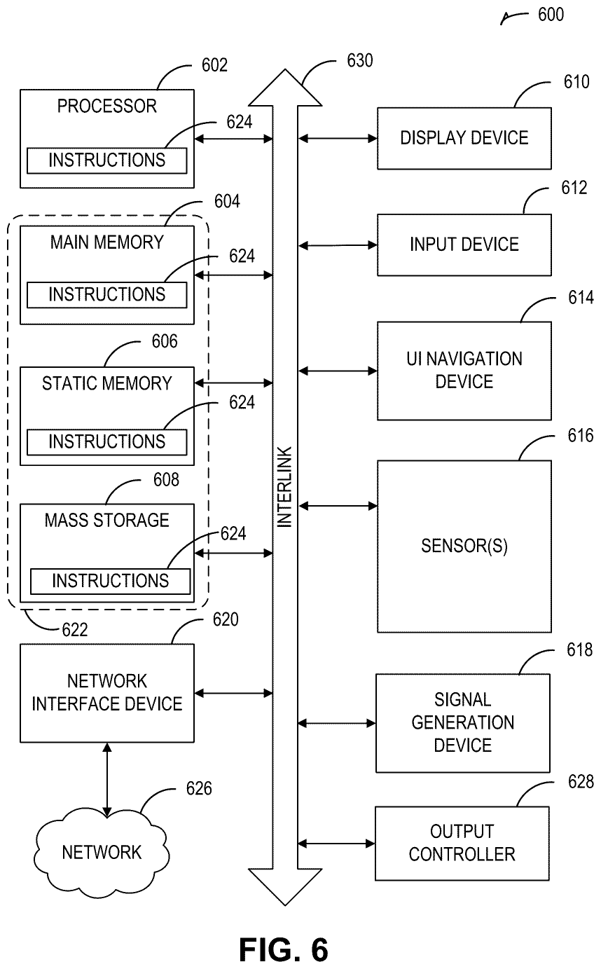

One or more communication interfaces can be used to transfer the host IO commands 125 between the memory system 110 and one or more other components of the host device 120, such as a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. The host device 120 can include a host system, an electronic device, a processor, a memory card reader, or one or more other electronic devices external to the memory system 110. In some examples, the host device 120 may be a machine having some portion, or all, of the components discussed in reference to the machine 600 of FIG. 6.

In an example, the host operation processing 155 is used to interpret and process the host IO commands 125 (e.g., read and write commands) and initiate accompanying commands in the controller 140 and the memory device 130 to accomplish the host IO commands 125. Further, the host operation processing 155 may coordinate timing, conditions, and parameters of the program control 160 in response to the host IO commands 125, temperature monitoring 150, and error detection processing 190. Communication between the controller 140 and the memory device 130 may make use of SCSI (Small Computer System Interface), NVMe (non-volatile memory express), other NVM protocols, or any suitable combination thereof. For example, SCSI may be used for UFS and NVMe may be used for SSD.

The temperature monitoring 150 operates, in some example embodiments, to measure or monitor temperature of the memory device 130. A temperature value may be stored in the memory 144 or the storage media 148. The stored temperature value may be used to determine an acceleration factor for aging of the memory device 130.

The program control 160 can include, among other things, circuitry or components (hardware and/or software) configured to control memory operations associated with writing data to, reading data from, or erasing one or more memory cells of the memory device 130 coupled to the memory controller 140. In an example, the program control 160 operates to identify parameters in the memory device 130 and controller 140 for scheduling and conducting scan operations. The program control 160 further operates to initiate and perform the temperature monitoring 150 based on these or other parameters, through synchronous or asynchronous event processing.

The read voltage control 170, in some example embodiments, is used to establish, change, and provide a voltage value used to read a particular area of memory (such as a respective block in the memory device 130). For example, the read voltage control 170 may implement various positive or negative offsets in order to read respective memory cells and memory locations (e.g., pages, blocks, dies) including the respective memory cells. A voltage level shifter may be used to transition control signals from a first power domain to control signals in a second power domain. The operating voltage of the second power domain may be controlled by the read voltage control 170. For example, a common ground may be used in the two power domains, a fixed voltage source used as the operating voltage of the first power domain, and the output of a voltage source, configured by the read voltage control 170, used as the operating voltage of the second power domain.

In an example, the verify calibration 180 is used to establish (e.g., change, update, reset, etc.) whether or not a verify operation should be performed after a program operation. The verify calibration 180 may be implemented based on a number or percentage of bits in the NAND memory device 130 that were successfully programmed at a lower voltage level.

The error detection processing 190, in some example embodiments, may detect a recoverable error condition (e.g., a RBER value or an RBER trend), an unrecoverable error condition, or other measurements or error conditions for a memory cell, a group of cells, or larger areas of the memory array (e.g., averages or samples from a block, group of blocks, die, group of dies, etc.).

Additionally, the sampling and read operations that are performed in a read scan by the program control 160 may allow configuration, such as from a specification (e.g., a determined setting or calculation) of: a size of data (e.g., data corresponding to a page, block, group of blocks, die) that is programmed; a number of pages in total that are programmed; a number of pages within a block that are programmed; whether certain cells, pages, blocks, dies, or certain types of such cells, pages, blocks, dies are or are not programmed; and the like. Likewise, the program control 160 may control or allow configuration of the number of program cycles that are performed before the first verify cycle, the number of program cycles that are performed between verify cycles, the number of bits to be successfully programmed at each level before next-level verification begins, or any suitable combination thereof.

In addition to the techniques discussed herein, other types of maintenance operations may be implemented by the control modules 142 in the controller 140. Such operations may include garbage collection or reclamation, wear leveling, block management, and other forms of background activities performed upon the memory device 130. Such background activities may be triggered during an idle state, such as immediately following or concurrently with a read scan operation.

The program control 160 can include an error correction code (ECC) component, which can include, among other things, an ECC engine or other circuitry configured to detect or correct errors associated with writing data to or reading data from one or more memory cells of the memory device 130 coupled to the memory controller 140. The memory controller 140 can be configured to actively detect and recover from error occurrences (e.g., bit errors, operation errors, etc.) associated with various operations or storage of data, while maintaining integrity of the data transferred between the host device 120 and the memory system 110, or maintaining integrity of stored data (e.g., using redundant RAID storage, etc.), and can remove (e.g., retire) failing memory resources (e.g., memory cells, memory arrays, pages, blocks, etc.) to prevent future errors.

The memory device 130 can include several memory cells arranged in, for example, a number of devices, planes, sub-blocks, blocks, or pages. As one example, a 48 GB TLC NAND memory device can include 18,592 bytes (B) of data per page (16,384+2208 bytes), 1536 pages per block, 548 blocks per plane, and 4 or more planes per device. As another example, a 32 GB MLC memory device (storing two bits of data per cell [i.e., 4 programmable states]) can include 18,592 bytes (B) of data per page (16,384+2208 bytes), 1024 pages per block, 548 blocks per plane, and 4 planes per device, but with half the required write time and twice the program/erase (P/E) cycles as a corresponding TLC memory device. Other examples can include other numbers or arrangements. In some examples, a memory device, or a portion thereof, may be selectively operated in SLC mode, or in a desired MLC mode (such as TLC, QLC, etc.).

In operation, data is typically written to or read from the memory system 110 in pages, and erased in blocks. However, one or more memory operations (e.g., read, write, erase, etc.) can be performed on larger or smaller groups of memory cells, as desired. The data transfer size of a NAND memory system 110 is typically referred to as a page, whereas the data transfer size of a host is typically referred to as a sector.

Although a page of data can include a number of bytes of user data (e.g., a data payload including a number of sectors of data) and its corresponding metadata, the size of the page often refers only to the number of bytes used to store the user data. As an example, a page of data having a page size of 4 KB may include 4 KB of user data (e.g., 8 sectors assuming a sector size of 512 B) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory devices 130 can provide for different page sizes, or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code data than a memory device with a lower bit error rate). As an example, a multi-level cell (MLC) NAND flash device may have a higher bit error rate than a corresponding single-level cell (SLC) NAND flash device. As such, the MLC device may require more metadata bytes for error data than the corresponding SLC device.

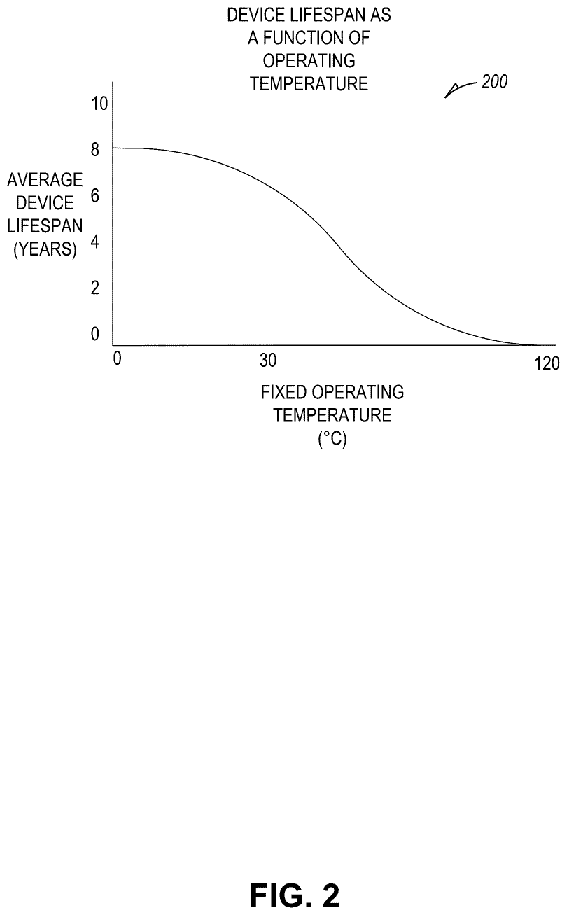

FIG. 2 shows a graph 200 of average device lifespan for a memory component as a function of a fixed operating temperature, in accordance with some embodiments of the present disclosure. While different electronic devices will have different lifespans depending on their designs and operating characteristics, in general, the lifespan of a device decreases as the operating temperature of the device increases. Past some critical temperature, the device can be expected to fail immediately. In the example of FIG. 2, the device has an average lifespan of about six years at 30° C. If the device is kept colder, at 0° C., the lifespan increases by about two years. At around 120° C., the lifespan drops to zero.

If a device is configured with a fixed lifespan based on an expected operating temperature (e.g., six years based on an expected operating temperature of 30° C.), the actual lifespan could be shorter if higher temperatures are encountered. As a result, the device could fail unexpectedly, causing loss of data. Alternatively, if the highest temperature experienced is used to estimate the lifespan, a relatively brief exposure to a high temperature (e.g., 100° C. for 10 minutes) could result in a drastically reduced lifespan estimate. As a result, the device could be replaced sooner than is actually necessary, causing waste.

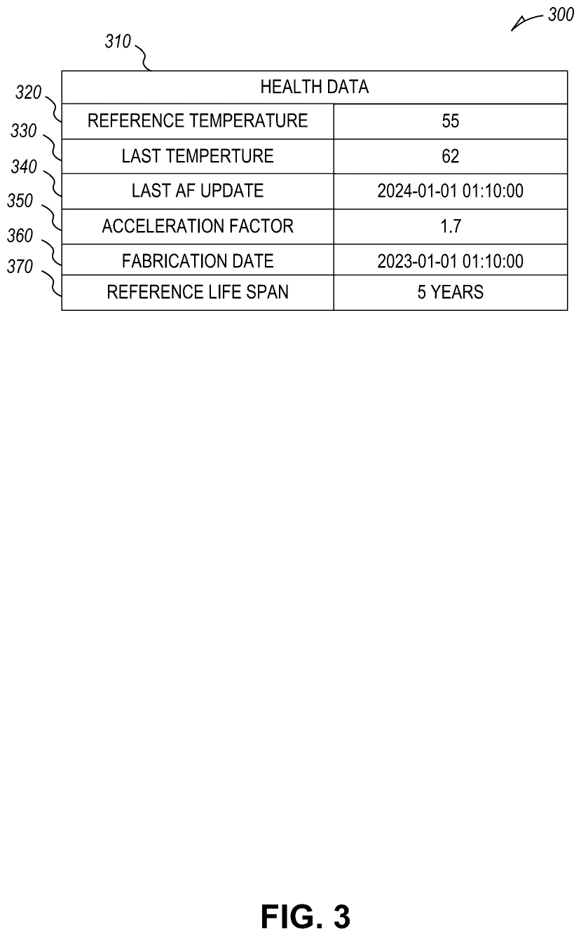

FIG. 3 is a block diagram 300 of an example data format 310, suitable for use in storing data for use in determining and using an acceleration factor for aging of a memory component, in accordance with some embodiments of the present disclosure. The data format 310, for storing health data for a memory device, includes a reference temperature 320, a last temperature 330, a last acceleration update time 340, an acceleration factor 350, a fabrication date 360, and a reference lifespan 370.

The acceleration factor can be calculated using the Arrhenius equation and the temperatures T₁ and T₂. The acceleration factor represents the ratio of the failure rates at two different temperatures, indicating how much faster a reaction or failure mechanism occurs at a higher temperature compared to a lower temperature. The acceleration factor (AF) can be calculated as follows:

$$AF = \frac{{k}_{2}}{{k}_{1}} = exp ( \frac{{E}_{a}}{R} ( \frac{1}{{T}_{1}} - \frac{1}{{T}_{2}} ) )$$

In this equation:
AF represents the acceleration factor.
k₁ and k₂ are the rate constants or failure rates at temperatures T₁ and T₂ respectively.
Eₐ is the activation energy. Parameter given by the storage technology being used.
R is the gas constant.
T₁ and T₂ are the temperatures in Kelvin
exp(x) is another notation for e^{x}

The expected lifetime at T₁ is divided by the AF to determine the expected lifetime at T₂. To calculate the equivalent AF with respect to a reference temperature (T_{ref}) for a generic temperature profile T(t), in which the temperature is not constant, the formula becomes as follows:

$$AF = {\int }_{{t}_{0}}^{{t}_{n}} exp ( \frac{{E}_{a}}{R} ( \frac{1}{T ( t )} - \frac{1}{{T}_{ref}} ) ) dt$$

In this formula:
AF represents the acceleration factor.
k₁ and k₂ are the rate constants or failure rates at temperatures T₁ and T₂ respectively.
Eₐ is the activation energy.
R is the gas constant.
T(t) represents the temperature at time t.
T_{ref} is the reference temperature.
t₀ and tₙ are the starting and ending times of the temperature measurements.

In order to account for temperature variations over time, it is necessary to consider multiple temperature measurements taken at different intervals, denoted as (T₁, ΔT1), (T₂, ΔT2), . . . , (Tn, ΔTn). By solving the integral, the equivalent AF with respect to a reference temperature, T_{ref} is found. The trapezoidal algorithm may be used to numerically approximate the integral. The trapezoidal rule involves dividing the integral into smaller intervals and approximating the area under each interval using trapezoids. The real-time calculation of this formula may be implemented within the Non-Volatile Memory Firmware (NVM FW) and stored in a dedicated SMART module for future reference. The trapezoidal approximation of the integral is:

$$AF ( {t}_{n} ) = {\sum }_{i = 1}^{n - 1} \frac{Δ {t}_{i}}{2} [ exp ( \frac{{E}_{a}}{R} ( \frac{1}{{T}_{i}} - \frac{1}{{T}_{ref}} ) ) + exp ( \frac{{E}_{a}}{R} ( \frac{1}{{T}_{i + 1}} - \frac{1}{{T}_{ref}} ) ) ]$$

In this formula:
AF represents the acceleration factor.
k₁ and k₂ are the rate constants or failure rates at temperatures T₁ and Description.
Eₐ is the activation energy.
R is the gas constant.
Tᵢ represents the temperature at time i.
tᵢ is the time when the temperature measurement occurred

The trapezoidal approximation may be rewritten as:

$$AF ( {t}_{n + 1} ) = AF ( {t}_{n} ) + \frac{Δ {t}_{n}}{2} [ exp ( \frac{{E}_{a}}{R} ( \frac{1}{{T}_{n}} - \frac{1}{{T}_{ref}} ) ) + exp ( \frac{{E}_{a}}{R} ( \frac{1}{{T}_{n + 1}} - \frac{1}{{T}_{ref}} ) ) ]$$

Thus, for time tₙ₊₁, determining the current AF uses a previous AF (e.g., the acceleration factor 350) and a trapezoidal approximation of an integral covering the time elapsed since the previous AF was determined. The trapezoidal approximation includes terms for the temperature at which the previous AF was calculated (e.g., the last temperature 330), and a reference temperature (e.g., the reference temperature 320). Additionally, determining the AF uses an amount of time elapsed since the calculation of the previous AF, which can be determined by taking a difference between a current time and the last AF update time 340. Thus, the data structure 310 may be used to determine an updated AF value. After the AF value is updated, the last temperature 330, last AF update time 340, and the acceleration factor 350 are updated accordingly.

The reference lifespan 370 may be divided by the acceleration factor 350 to determine an adjusted lifespan. For example, if the lifespan of the device, at a steady operating temperature of 55° C. is five years, and the acceleration factor, based on temperatures actually experienced, is 1.7, then the adjusted lifespan is about 2.94 years. Using the fabrication date 360 and a current date, the current age of the non-volatile memory device can be determined. For example, if the current date is Jan. 1, 2024 01:10:00, as shown in the last AF update time 340, and the fabrication date is Jan. 1, 2023 01:10:00, the device is one year old. Subtracting the age of the device from the adjusted lifespan of the device gives an estimated remaining life of the device. In this example, the device has about 1.94 years of estimated life remaining.

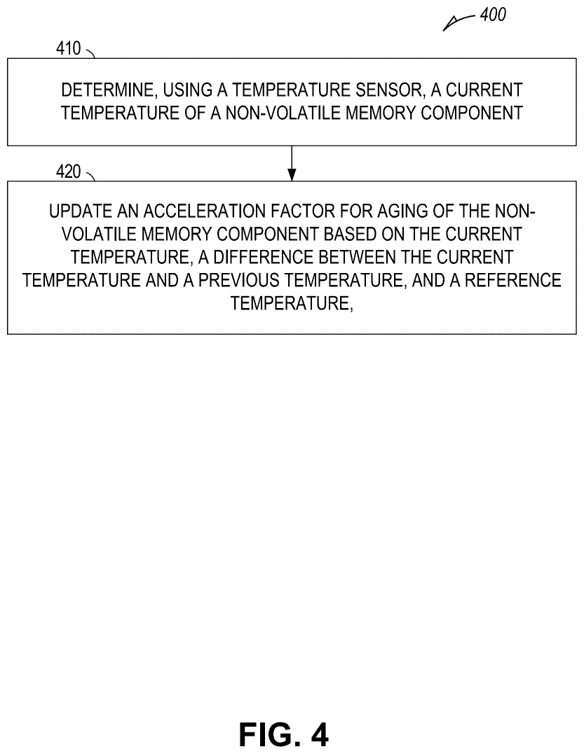

FIG. 4 is a flow diagram of an example method 400 for updating an acceleration factor for aging of a memory component, in accordance with some embodiments of the present disclosure. The method 400 includes operations 410 and 420. By way of example and not limitation, the method 400 is described as being performed by the controller 140 of FIG. 1 in conjunction with the memory device 130 of FIG. 1.

In operation 410, the controller 140 determines, using a temperature sensor, a current temperature of a non-volatile memory component (e.g., the memory device 130 or a sub-component thereof). The controller 140, in operation 420, updates an acceleration factor for aging of the non-volatile memory component. The update at operation 420 can be based on the current temperature, a difference between the current temperature and a previous temperature, and a reference temperature. For example, the equation below may be used.

$$AF ( {t}_{n + 1} ) = AF ( {t}_{n} ) + \frac{Δ {t}_{n}}{2} [ exp ( \frac{{E}_{a}}{R} ( \frac{1}{{T}_{n}} - \frac{1}{{T}_{ref}} ) ) + exp ( \frac{{E}_{a}}{R} ( \frac{1}{{T}_{n + 1}} - \frac{1}{{T}_{ref}} ) ) ]$$

In the equation above, Tₙ₊₁ is the current temperature measured in operation 410, Tₙ is the previous temperature, and T_{ref} is the reference temperature. The previous value for the acceleration factor is AF(tₙ). The remaining portion of the right-hand-side of the equation is a trapezoidal approximation of the next term of an integral of the Arrhenius equation. After the updating is performed in operation 420, the value for the acceleration factor is AF(tₙ₊₁).

The previous temperature Tₙ, the reference temperature T_{ref}, and the previous acceleration factor AF(tₙ) may be accessed from the memory 144 of FIG. 1, using the data structure 310 of FIG. 3. After operation 420 is performed, the last temperature 330, the last AF update time 340, and the acceleration factor 350 may be updated.

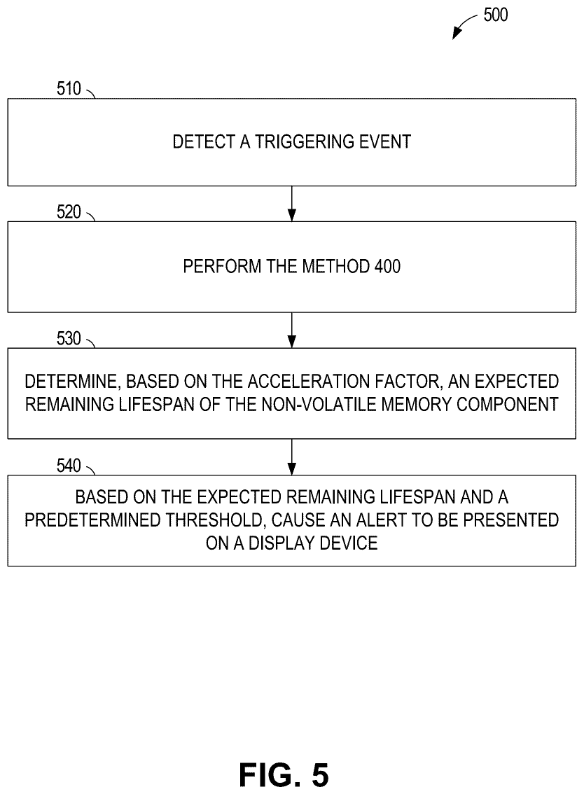

FIG. 5 is a flow diagram of an example method 500 for determining and applying an expected remaining lifespan of a memory component based on an acceleration factor, in accordance with some embodiments of the present disclosure. The method 500 includes operations 510, 520, 530, and 540. By way of example and not limitation, the method 500 is described as being performed by the controller 140 of FIG. 1 in conjunction with the memory device 130 of FIG. 1.

In operation 510, the controller 140 detects a triggering event. For example, the host 120 may send a host IO command 125 to update the acceleration factor. The host command may be an administrative command that directly requests an update of the acceleration factor. Alternatively, the host command may be a memory shutdown command that requests the controller 140 to perform appropriate operations for safely shutting down memory and the controller 140 may determine to update the acceleration factor as one of a set of memory shutdown operations.

As another example, the controller 140 may determine that a predetermined period of time (e.g., one minute, ten minutes, one hour, or one day, etc.) has elapsed since the last acceleration factor update. As still another example, the triggering event may comprise entry into a low-power non-operational state, either in response to receiving a host command to enter such a state or detection of an elapse of a predetermined period of time without receiving a host command (e.g., five minutes, ten minutes, or an hour, etc.).

In response to the triggering event, the controller 140 performs the method 400 to update an aging acceleration factor for a non-volatile memory device. In the context of FIG. 5, the method 400 is referenced as operation 520. Thus, updating of the acceleration factor is in response to a triggering event in this example embodiment. The updating of the acceleration factor may comprise updating a SMART log (e.g., a data structure in non-volatile memory in the format of FIG. 3).

At operation 530, the controller 140 determines, based on the acceleration factor, an expected remaining lifespan of the non-volatile memory component. The data structure of FIG. 3 may be used. For example, the reference lifespan 370 may be divided by the acceleration factor 350 to determine an adjusted lifespan. The fabrication date 360 may be subtracted from a current date to determine an age of the device. The age of the device may be subtracted from the adjusted lifespan to determine the expected remaining lifespan.

In operation 540, based on the expected remaining lifespan and a predetermined threshold (e.g., thirty days), the controller 140 or the host 120 causes an alert to be presented on a display device. For example, the controller 140 may report that the non-volatile memory device is expected to fail soon. The report can be provided to the host 120 using a status register or an interrupt. The host 120 may cause an alert to be presented on a display device (e.g., a computer monitor or smartphone screen), allowing a user to replace the non-volatile memory device before it fails. The alert may be user-configurable to allow for customization based on specific user needs and preferences. For example, the alert may only be presented when the predicted remaining life falls below a user-specified threshold (e.g., one day, one week, or one month).

As another example, the host 120 may be integrated into a vehicle and the alert may be presented on a control panel of the vehicle. As still another example, the host 120 may be integrated into a vehicle that includes a wireless communication device, and the host 120 may transmit the updated acceleration factor or the expected remaining lifespan to a server via the wireless network communication device. In response, the server may cause the display of an alert to an administrator.

Calculating the acceleration factor using the Arrhenius Law and relating it to the overall SSD lifetime offers several advantages in terms of understanding and predicting the reliability and longevity of the SSD (or other non-volatile memory device).

The acceleration factor allows for the estimation of the failure rates and degradation mechanisms of the non-volatile memory device at various operating temperatures. This enables proactive monitoring, maintenance, and replacement strategies to be implemented before failures actually occur, enhancing overall system reliability.

The acceleration factor calculations can provide valuable insights into the impact of temperature variations on the non-volatile memory device's reliability. This information can be used during the design and selection process to optimize the choice of components, materials, and operational parameters that are better suited for the desired operating conditions. This helps manufacturers and system integrators make informed decisions about product specifications, ensuring improved reliability and performance.

By accounting for the effect of temperature on the non-volatile memory device's degradation, the acceleration factor calculation helps in estimating the device's lifetime. This aids in planning for replacement or maintenance schedules and enables users to make informed decisions regarding the use and deployment of non-volatile memory devices in critical applications.

Example 1 is a system comprising: a non-volatile memory component; a temperature sensor; and a processing device programmed to perform operations comprising: determining, using the temperature sensor, a current temperature; and updating an acceleration factor for aging of the non-volatile memory component, wherein the update is based on at least one of the current temperature, a difference between the current temperature and a previous temperature, and a reference temperature.

In Example 2, the subject matter of Example 1, wherein the updating of the acceleration factor is in response to a triggering event.

In Example 3, the subject matter of Example 2, wherein the triggering event comprises execution of a host command.

In Example 4, the subject matter of Examples 2-3, wherein the triggering event comprises receipt of a memory shutdown command.

In Example 5, the subject matter of Examples 2-4, wherein the triggering event comprises entry into a low-power non-operational state.

In Example 6, the subject matter of Examples 2-5, wherein the triggering event comprises elapsing of a predetermined amount of time since a previous update of the acceleration factor.

In Example 7, the subject matter of Examples 2-6, wherein the operations further comprise: determining, based on the acceleration factor, an expected remaining lifespan of the non-volatile memory component; and based on the expected remaining lifespan and a predetermined threshold, causing an alert to be presented on a display device.

In Example 8, the subject matter of Examples 1-7, wherein the updating of the acceleration factor comprises determining a trapezoidal approximation of a term of an integral of the Arrhenius equation.

In Example 9, the subject matter of Examples 1-8 includes a wireless network communication device, and wherein the operations further comprise transmitting the updated acceleration factor to a server via the wireless network communication device.

Example 10 is a method comprising: determining, by a processing device and using a temperature sensor, a current temperature; and updating, by the processing device, an acceleration factor for aging of a non-volatile memory component, wherein the updating is based on at least one of the current temperature, a difference between the current temperature and a previous temperature, and a reference temperature.

In Example 11, the subject matter of Example 10, wherein the updating the acceleration factor is in response to a triggering event.

In Example 12, the subject matter of Example 11, wherein the triggering event comprises execution of a host command.

In Example 13, the subject matter of Examples 11-12, wherein the triggering event comprises receipt of a memory shutdown command.

In Example 14, the subject matter of Examples 11-13, wherein the triggering event comprises entry into a low-power non-operational state.

In Example 15, the subject matter of Examples 11-14, wherein the triggering event comprises elapsing of a predetermined amount of time since a previous update of the acceleration factor.

In Example 16, the subject matter of Examples 10-15 includes determining, based on the updated acceleration factor, an expected remaining lifespan of the non-volatile memory component; and based on the expected remaining lifespan and a predetermined threshold, causing an alert to be presented on a display device.

In Example 17, the subject matter of Examples 10-16, wherein the updating the acceleration factor comprises determining a trapezoidal approximation of a term of an integral of the Arrhenius equation.

Example 18 is a non-transitory machine-readable storage medium comprising instructions that, when executed by a processing device, cause the processing device to perform operations comprising: determining, using a temperature sensor, a current temperature; and updating an acceleration factor for aging of a non-volatile memory component based on at least one of the current temperature, a difference between the current temperature and a previous temperature, and a reference temperature.

In Example 19, the subject matter of Example 18, wherein the updating of the acceleration factor is in response to a triggering event.

In Example 20, the subject matter of Example 19, wherein the triggering event comprises execution of a host command.

Example 21 is an apparatus comprising means to implement any of Examples 1-20.

FIG. 6 illustrates an example machine of a machine 600 within which a set of instructions can be executed for causing the machine to perform any one or more of the methodologies discussed herein. In some embodiments, the machine 600 can correspond to a host system that includes, is coupled to, or uses a memory system (e.g., the memory system 100 of FIG. 1) or can be used to perform the operations of a controller (e.g., to execute an operating system to execute instructions 624 for performing BF scans and adjusting read voltages based on BF bins). In an example, the controller can include memory to store offset voltage adjustments for memory components. The instructions 624 may include, for example, instructions 624 and/or logic described herein. In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

Examples, as described herein, can include, or can operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 600.

In alternative embodiments, the machine 600 can operate as a standalone device or can be connected (e.g., networked) to other machines. In a networked deployment, the machine 600 can operate in the capacity of a server machine, a client machine, or both in server-client network environments. In an example, the machine 600 can act as a peer machine in a peer-to-peer (P2P) (or other distributed) network environment. The machine 600 can be a PC, a tablet PC, a STB, a PDA, a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 600 (e.g., computer system) can include a hardware processor 602 (e.g., a central processing unit (CPU), a graphics processing unit (GPU), a hardware processor core, or any combination thereof), a main memory 604, a static memory 606 (e.g., memory or storage for firmware, microcode, a basic-input-output (BIOS), unified extensible firmware interface (UEFI), etc.), and mass storage device 608 (e.g., hard drives, tape drives, flash storage, or other block devices) some or all of which can communicate with each other via an interlink 630 (e.g., bus). The machine 600 can further include a display device 610, an alphanumeric input device 612 (e.g., a keyboard), and a user interface (UI) navigation device 614 (e.g., a mouse). In an example, the display device 610, the input device 612, and the UI navigation device 614 can be a touch screen display. The machine 600 can additionally include a signal generation device 618 (e.g., a speaker), a network interface device 620, and one or more sensor(s) 616, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 602, the main memory 604, the static memory 606, or the mass storage device 608 can be, or include, a machine-readable media 622 on which is stored one or more sets of data structures or instructions 624 (e.g., software) embodying or used by any one or more of the techniques or functions described herein. The instructions 624 can also reside, completely or at least partially, within any of registers of the hardware processor 602, the main memory 604, the static memory 606, or the mass storage device 608 during execution thereof by the machine 600. In an example, one or any combination of the hardware processor 602, the main memory 604, the static memory 606, or the mass storage device 608 can constitute the machine-readable media 622. While the machine-readable media 622 is illustrated as a single medium, the term “machine-readable medium” can include a single medium or multiple media (e.g., a centralized or distributed database, or associated caches and servers) configured to store the one or more instructions 624.

The term “machine-readable medium” can include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media can include: non-volatile memory, such as semiconductor memory systems (e.g., electrically programmable read-only memory (EPROM), electrically erasable programmable read-only memory [EEPROM]) and flash memory systems; magnetic disks, such as internal hard disks and removable disks; magneto-optical disks; and CD-ROM and DVD-ROM disks.

In an example, information stored or otherwise provided on the machine-readable media 622 can be representative of the instructions 624, such as instructions 624 themselves or a format from which the instructions 624 can be derived. This format from which the instructions 624 can be derived can include source code, encoded instructions (e.g., in compressed or encrypted form), packaged instructions (e.g., split into multiple packages), or the like. The information representative of the instructions 624 in the machine-readable media 622 can be processed by processing circuitry into the instructions to implement any of the operations discussed herein. For example, deriving the instructions 624 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 can include assembly, compilation, or interpretation of the information (e.g., by the processing circuitry) to create the instructions 624 from some intermediate or preprocessed format provided by the machine-readable media 622. The information, when provided in multiple parts, can be combined, unpacked, and modified to create the instructions 624. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, compiled, or interpreted (e.g., into a library, stand-alone executable etc.) at a local machine, and executed by the local machine.

The instructions 624 can be further transmitted or received over a communications network 626 using a transmission medium via the network interface device 620 using any one of a number of transfer protocols (e.g., frame relay, internet protocol, transmission control protocol (TCP), user datagram protocol (UDP), hypertext transfer protocol (HTTP), etc.). Example communication networks can include a LAN, a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, P2P networks, among others. In an example, the network interface device 620 can include one or more physical jacks (e.g., Ethernet, coaxial, or phone jacks) or one or more antennas to connect to the network 626. In an example, the network interface device 620 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine-readable medium.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A system comprising:
a non-volatile memory component;
a temperature sensor; and
a processing device programmed to perform operations comprising:
determining, using the temperature sensor, a current temperature;
in response to detection of an elapse of a predetermined period of time without receiving a host command, entering a low-power non-operational state; and
based on detecting the entering into the low-power non-operational state, updating an acceleration factor for aging of the non-volatile memory component, wherein the update is based on at least one of the current temperature and a reference temperature.

2. (canceled)

3. (canceled)

4. (canceled)

5. (canceled)

6. (canceled)

7. The system of claim 1, wherein the operations further comprise:
determining, based on the acceleration factor, an expected remaining lifespan of the non-volatile memory component; and
based on the expected remaining lifespan and a predetermined threshold, causing an alert to be presented on a display device.

8. The system of claim 1, wherein the updating of the acceleration factor comprises determining a trapezoidal approximation of a term of an integral of the Arrhenius equation.

9. The system of claim 1, further comprising a wireless network communication device, and wherein the operations further comprise transmitting the updated acceleration factor to a server via the wireless network communication device.

10. A method comprising:
determining, by a processing device and using a temperature sensor, a current temperature;
in response to detection of an elapse of a predetermined period of time without receiving a host command, entering a low-power non-operational state; and
based on detecting the entering into the low-power non-operational state, updating, by the processing device, an acceleration factor for aging of a non-volatile memory component, wherein the updating is based on at least one of the current temperature and a reference temperature.

11. (canceled)

12. (canceled)

13. (canceled)

14. (canceled)

15. (canceled)

16. The method of claim 10, further comprising:
determining, based on the updated acceleration factor, an expected remaining lifespan of the non-volatile memory component; and
based on the expected remaining lifespan and a predetermined threshold, causing an alert to be presented on a display device.

17. The method of claim 10, wherein the updating the acceleration factor comprises determining a trapezoidal approximation of a term of an integral of the Arrhenius equation.

18. A non-transitory machine-readable storage medium comprising instructions that, when executed by a processing device, cause the processing device to perform operations comprising:
determining, using a temperature sensor, a current temperature;
in response to detection of an elapse of a predetermined period of time without receiving a host command, entering a low-power non-operational state; and
based on detecting the entering into the low-power non-operational state, updating an acceleration factor for aging of a non-volatile memory component based on the current temperature, a difference between the current temperature and a previous temperature, and a reference temperature.

19. (canceled)

20. (canceled)
